(19) United States
(12) Patent Application Publication
(10) Pub. No.: US 2025/0144789 A1
(43) Pub. Date: May 8, 2025

(54) ROBOT WITH DRIVE LINKAGE AND END EFFECTOR ORIENTATION DETERMINING LINKAGE

(71) Applicant: Fruitcore Robotics GmbH, Konstanz (DE)

(72) Inventors: Jens RIEGGER, Konstanz (DE); Manuel Tobias FREY, Konstanz (DE)

(21) Appl. No.: 18/837,289

(22) PCT Filed: Feb. 10, 2023
(86) PCT No.: PCT/EP2023/053354

§ 371 Date: Aug. 9, 2024

(30) Foreign Application Priority Data
Feb. 11, 2022 (EP) 22156308.3

(51) Int. Cl. B25J 9/10; B25J 9/16

(52) U.S. Cl. CPC B25J 9/106; B25J 9/1653

(57) ABSTRACT

A robot includes a base rotatable about a first robot axis, a first drive, a pivot arm pivotally connected to the base about a second robot axis, an end effector adapted to be moved by pivoting the pivot arm, and an end effector orientation determining linkage kinematically arranged between the base and the end effector. A first drive linkage for pivoting the pivot arm includes a first crank pivotally connected to the base about a first pivot axis and a first link connecting the first crank and the pivot arm. The first drive is adapted for pivoting the first crank. The end effector is pivotally connected to a support arm driven by a second drive linkage around a fourth robot axis, wherein the end effector orientation determining linkage is adapted to orient the end effector about the fourth robot axis.

The present invention relates to a robot, in particular a robotic palletizer, and to the use of a robot as a robotic palletizer.

DE 295 10 012 U1 and US 2012/0067156 A1 describe robots with an articulated arm, parallelogram linkages and an actuator connected at the free end of the articulated arm. WO 2017/118953 A1 discloses four-bar-linkages for driving both a pivot arm and a support arm.

According to a first aspect of the invention, a robot is provided, in particular a robotic palletizer is provided. The robot may comprise a base, which may be in particular rotatable about a first robot axis. The robot may comprise a first drive. The robot may comprise a pivot arm pivotally connected to the base about a second robot axis. The robot may comprise an end effector. The end effector may be adapted to be moved by pivoting the pivot arm. The robot may comprise an end effector orientation determining linkage. The end effector orientation determining linkage may be kinematically arranged in between the base and the end effector. The end effector orientation determining linkage may be adapted for determining an orientation of the end effector when the pivot arm is pivoted. The robot may comprise a first drive linkage for pivoting the pivot arm. The first drive linkage may comprise a first crank pivotally connected to the base about a first pivot axis. The robot may comprise a first link connecting the first crank and the pivot arm. The first drive may be adapted for pivoting the first crank. The end effector orientation determining linkage may be adapted for determining an orientation of the end effector when the pivot arm is pivoted. In particular, the orientation of the end effector may be kinematically dependent of the orientation of the pivot arm. If the robot is provided with a support arm, the orientation of the end effector may be kinematically dependent of the orientation of the pivot arm and support arm. The end effector orientation determining linkage may be directly coupled to the end effector. The end effector orientation determining linkage may enable that the end effector is always in the same predetermined orientation, when the pivot arm and support arm are in the same position. This enables swiftly picking up and depositing articles, which are provided in a predetermined orientation to the robot and shall be deposited in predetermined orientation by the robot.

The end effector orientation determining linkage may comprise or be formed of a first parallelogram linkage. The first parallelogram linkage may be adapted for maintaining an orientation of the end effector, when the pivot arm is pivoted. This enables swiftly picking up and depositing articles, while maintaining the orientation of the articles.

In particular, the first drive may be indirectly connected to the pivot arm via the first crank and the first link. A first transmission may be provided in between the first drive and the pivot arm. The first transmission may be a gear box. The first drive may be arranged separate from the pivot arm. The first drive may be arranged in a distance to the second robot axis.

The first parallelogram linkage may be adapted for maintaining the end effector in constant relative orientation regarding the base, during pivoting of the pivot arm.

The end effector may comprise a tool holder. The tool holder may be integral part of the robot. The tool holder may be substantially free of tolerance movements with respect to the robot.

The robot may be adapted for palletizing articles, in particular packets or packages. A system comprising the robot and a conveying means for articles may be provided. The robot may be arranged, such that the robot may pick up articles from the conveying means. The robot may be arranged, such that the robot may place article on the conveying means. The robot may be adapted for end-of-line palletizing. The conveying means may convey articles to an operating area of the robot. The robot may be functionally combined with the conveying means to form an end-of-line palletizing unit.

The first drive linkage may comprise a first rocker. The first rocker may be pivotally connected to the base. The first link may comprise a first link element and a second link element. The first link element may be pivotally connected to the first crank. The second link element may be pivotally connected to the pivot arm. The first link element and the second link element may be pivotally connected via a first hinge. The first rocker may be pivotally connected to the first hinge. The first drive linkage may form two four-bar linkages. In particular, the first drive is indirectly connected to the pivot arm via the two four-bar linkages to incline the pivot arm, to move the end effector to a level of the base.

The pivot arm may comprise a rocker section and an arm section. The rocker section and the arm section may extend in different directions with respect to the second robot axis. The second link element may be pivotally connected to the rocker section. The rocker section may be configured as a lever arm to pivot the pivot arm via the first drive linkage and the first drive. The rocker arm section may have a length with respect to the second robot axis in a range between 0.3 meter and 1.5 meter, preferably in a range between 0.5 meter and 1 meter.

In particular, the first drive linkage provides a first transmission ratio between a rotation of the first crank and a rotation of the pivot arm about the second robot axis. The first transmission ratio may vary with a first rotation angle of the first crank in a first transmission range. The robot may be adapted to limit the rotation of the first crank to a first rotation range, in particular by rotation limits specified in a controller of the robot. In the first rotation range, the first transmission ratio may be within a range of 1 to 10, in particular in a range of 1 to 7, more in particular in a range of 1 to 5 and preferably in a range of 1 to 3.

The derivative of the first transmission ratio with respect to the first rotation angle may be in a range between 0.01 per degree and 0.5 per degree in the first rotation range. The derivative of the first transmission ratio with respect to the first rotation angle may be in a range between 0.05 per degree and 0.15 per degree in the first rotation range. The derivative of the first transmission ratio with respect to the first rotation angle may be in a range between 0.08 per degree and 0.12 per degree in the first rotation range. The rocker section and the arm section may be integral part of the pivot arm.

The rocker section and the arm section may be separate parts, fixedly connected to each other to form the pivot arm.

The arm section may extend along a longitudinal direction. A transversal direction may be perpendicular to the longitudinal direction. The pivot arm may comprise transversal sides which are normal to the transversal direction.

The end effector orientation determining linkage and the first drive linkage may be adapted to be at least partially and at least temporally arranged on one transversal side of the pivot arm.

The end effector orientation determining linkage and the first drive linkage may be adapted to at least partially and at least temporally overlap in the transversal direction. Overlapping areas of the end effector orientation determining linkage and the first drive linkage may provide a compact construction.

The end effector orientation determining linkage and the first drive linkage may be arranged on opposite transversal sides of the pivot arm.

The end effector orientation determining linkage may comprise a first end effector orientation determining four-bar linkage. In particular, the first end effector orientation determining fourbar linkage may comprise four links connected in a loop by four joints in the form of pivot connections. In particular, the orientation of a link connected to or formed by the base determines the orientation of an opposite link, wherein the opposite link may be formed by the end effector or the opposite link may be connected via further links to the end effector.

The first end effector orientation determining four-bar linkage and the first drive linkage may be adapted to be at least partially and at least temporally arranged on one transversal side of the pivot arm.

The first end effector orientation determining four-bar linkage and the first drive linkage may be adapted to at least partially and at least temporally overlap in the transversal direction. Overlapping areas of the first end effector orientation determining four-bar linkage and the first drive linkage may provide a compact construction.

The first end effector orientation determining four-bar linkage and the first drive linkage may be arranged on opposite transversal sides of the pivot arm.

The end effector orientation determining linkage may comprise a first parallelogram linkage with first, second, third and fourth parallelogram links. The first parallelogram link may be formed by a first section of the pivot arm. The first parallelogram link may extend from a first parallelogram pivot connection to a second parallelogram pivot connection. The first parallelogram linkage may comprise a second parallelogram link. The second parallelogram link may extend from the second parallelogram pivot connection to a third parallelogram pivot connection. The first parallelogram linkage may comprise a third parallelogram link. The third parallelogram link may extend from the third parallelogram pivot connection to a fourth parallelogram pivot connection. The first parallelogram linkage may comprise a fourth parallelogram link. The fourth parallelogram link may extend from the fourth parallelogram pivot connection to the first parallelogram pivot connection. In particular, when pivoting the pivot arm, the fourth parallelogram link and the second parallelogram link remain parallel to each other for maintaining the end effector in constant relative orientation regarding the base.

The fourth parallelogram link may be formed by a second section of the base. In particular, the fourth parallelogram link may be fixed in its orientation with respect to the base.

The robot may comprise an end effector reorientation drive. The fourth parallelogram link may be formed by a second crank. The second crank may be adapted to be pivotable around the second robot axis by means of the end effector reorientation drive for changing an orientation of the end effector.

The robot may comprise a connection assembly. The end effector may be connected to the connection assembly. The second parallelogram link may be formed by the connection assembly. The end effector may be arranged at an end of the pivot arm opposite to the connection of the pivot arm to the base. The robot may be adapted for use in a working area, wherein the working area may have a radius corresponding to a longitudinal length of the pivot arm. The working area may have a radius corresponding to a projection of the longitudinal length of the pivot arm onto the working area.

The robot may comprise a support arm. The support arm may be pivotally connected to the pivot arm around a third robot axis. The end effector may be pivotally connected to the support arm around a fourth robot axis. The first parallelogram linkage may be adapted to orient the end effector about the fourth robot axis. The robot may be adapted for use in a working area, wherein the working area may have a radius corresponding to a longitudinal length of the pivot arm and a longitudinal length of the support arm. The working area may have a radius corresponding to a projection of the longitudinal length of the pivot arm and a projection of the longitudinal length of the support arm onto the working area.

The at least first parallelogram linkage may maintain the end effector in constant relative orientation regarding the base when pivoting the pivot arm.

The at least first parallelogram linkage may maintain the end effector in constant relative orientation regarding the base when pivoting the support arm.

The connection assembly may comprise a connecting member.

The end effector orientation determining linkage may comprise a second end effector orientation determining four-bar linkage.

The connection assembly may comprise the second end effector orientation determining four-bar linkage. In particular, the second end effector orientation determining four-bar linkage may comprise a second parallelogram linkage. The second parallelogram linkage may comprise a fifth parallelogram link. The fifth parallelogram link may be formed by a third section of the support arm. The fifth parallelogram link may extend from the second parallelogram pivot connection to a fifth parallelogram pivot connection. The second parallelogram pivot connection may be about the third robot axis. The second parallelogram linkage may comprise a sixth parallelogram link. The sixth parallelogram link may be formed by the end effector. The sixth parallelogram link may extend from the fifth parallelogram pivot connection to a sixth parallelogram pivot connection. The fifth parallelogram pivot connection may be about the fourth robot axis. The second parallelogram linkage may comprise a seventh parallelogram link. The seventh parallelogram link may extend from the sixth parallelogram pivot connection to a seventh parallelogram pivot connection. The second parallelogram linkage may comprise an eighth parallelogram link. The eighth parallelogram link may be formed by the connecting member. The eighth parallelogram link may extend from the seventh parallelogram pivot connection to the second parallelogram pivot connection. The at least second parallelogram linkage may maintain the end effector in constant relative orientation regarding the base. The relative orientation of the end effector regarding the base may be adapted by pivoting the second crank.

The second end effector orientation determining four-bar linkage may be connected to the first end effector orientation determining four-bar linkage by means of the connecting member.

The second parallelogram linkage may be connected to the first parallelogram linkage by means of the connecting member. The first parallelogram linkage and the second parallelogram linkage may be kinematically arranged between the base and the end effector. The first end effector orientation determining four-bar linkage and the second end effector orientation determining four-bar linkage may be kinematically arranged between the base and the end effector. The first parallelogram linkage and the second parallelogram linkage may be adapted to maintain a relative orientation of the end effector regarding the base.

The connecting member may be formed in a triangle-shape. The connecting member may have the second parallelogram pivot connection, the third parallelogram pivot connection and the seventh parallelogram pivot connection at the vertices of the triangle-shape. The connecting member may connect the first parallelogram linkage with the second parallelogram linkage via a common pivot connection. In particular, the common pivot connection is the second parallelogram pivot connection.

The robot may comprise a second drive linkage. The robot may comprise a second drive. The second drive linkage may comprise a third crank. The third crank may be pivotally connected to the base about a second pivot axis. The second pivot axis may be coaxial with the second robot axis. The second drive linkage may comprise a second link. The second link may connect the third crank and the support arm. The second drive may be adapted for pivoting the third crank. The second drive linkage may form a four-bar linkage to pivot the support arm about the third robot axis via the second drive.

The four-bar linkage may provide a second transmission ratio between a rotation of the third crank and a rotation of the support arm about the third robot axis. The second transmission ratio may vary with a second rotation angle of the third crank in a second transmission range. The robot may be adapted to limit the rotation of the third crank to a second rotation range, in particular by rotation limits specified in a controller of the robot. In the second rotation range, the second transmission ratio may be within a range of 1 to 10, in particular in a range of 1 to 7, more in particular in a range of 1 to 5 and preferably in a range of 1 to 3.

The derivative of the second transmission ratio with respect to the second rotation angle may be in a range between 0.01 per degree and 0.5 per degree in the second rotation range. The derivative of the second transmission ratio with respect to the second rotation angle may be in a range between 0.05 per degree and 0.15 per degree in the second rotation range. The derivative of the second transmission ratio with respect to the second rotation angle may be in a range between 0.08 per degree and 0.12 per degree in the second rotation range.

The second drive linkage may comprise a second rocker. The second rocker may be pivotally connected to the pivot arm. The second link may comprise a third link element and a fourth link element. The third link element may be pivotally connected to the third crank. The fourth link element may be pivotally connected to the support arm. The third link element and the fourth link element may be pivotally connected via a second hinge. The second rocker may be pivotally connected to the second hinge.

The fourth parallelogram pivot connection may comprise a third axis, wherein the third axis may be coaxial with the second pivot axis.

The first rocker may be pivotally connected to the base about a fourth axis, wherein the third axis may be coaxial with the fourth axis.

The first parallelogram pivot connection may comprise a fifth axis.

The fifth axis may be coaxial with the second pivot axis and the third axis may be coaxial with the first pivot axis.

The robot may be adapted to lift and hold an article having a weight in a range between 0.01 kg and 14 kg. The robot may be adapted to lift and hold an article having a weight of at least 1 kg. The robot may be adapted to lift and hold an article having a weight of at least 3 kg.

The robot may be adapted to palletize an article at least to a height of 0.5 meters as measured from the bottom of the base.

The robot may have a working range in a range between 0.5 meter and 2 meter. The robot may have a working range of at least 1 meter.

According a second aspect of the present invention, there is provided a use of a robot as a robotic palletizer. The robotic palletizer may comprise a base. The base may in particular be rotatable around a first robot axis. The robotic palletizer may comprise a pivot arm pivotally connected to the base around a second robot axis. The robotic palletizer may comprise an end effector adapted to be moved by pivoting the pivot arm. The robotic palletizer may comprise a first parallelogram linkage. The first parallelogram linkage may be kinematically arranged in between the base and the end effector. The robotic palletizer may comprise a first crank. The first crank may be pivotally connected to the base around a first pivot axis. The robotic palletizer may comprise a first link. The first link may connect the first crank and the pivot arm. The robotic palletizer may comprise a first drive for pivoting the first crank. The use of the robot as the robotic palletizer may comprise to move the end effector by at least pivoting the pivot arm by pivoting the first crank while keeping an orientation of the end effector substantially constant by means of the first parallelogram linkage.

The first parallelogram linkage may be adapted for maintaining the end effector in constant relative orientation regarding the base, during pivoting of the pivot arm.

The end effector may comprise a linear drive or a linear actuator adapted to move the end effector towards the base or away from the base.

The end effector may comprise a rotatable part adapted to rotate at least a part of the end effector with respect to the pivot arm.

Exemplary embodiments will now be further described with reference to the figures in which:

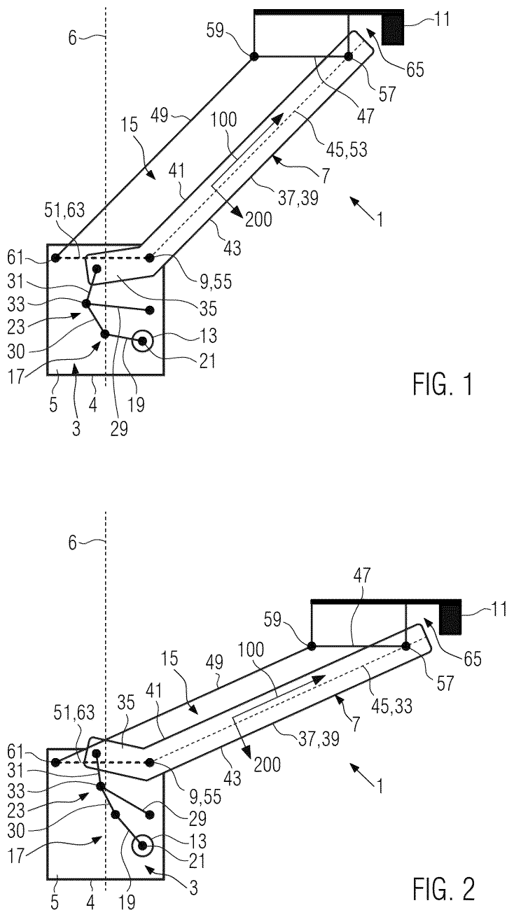

FIG. 1 shows a schematic representation of a robot according to a first embodiment, wherein the end effector is in a lifted position;

FIG. 2 shows a schematic representation of the robot shown in FIG. 1, wherein the end effector is in a lowered position;

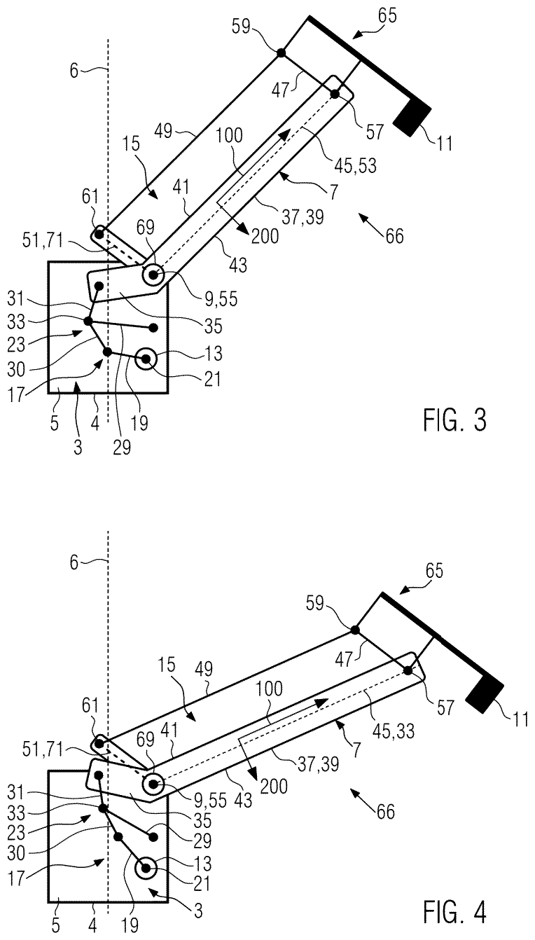

FIG. 3 shows a schematic representation of a robot according to a second embodiment, wherein the end effector is in a lifted position;

FIG. 4 shows a schematic representation of the robot shown in FIG. 3, wherein the end effector is in a lowered position;

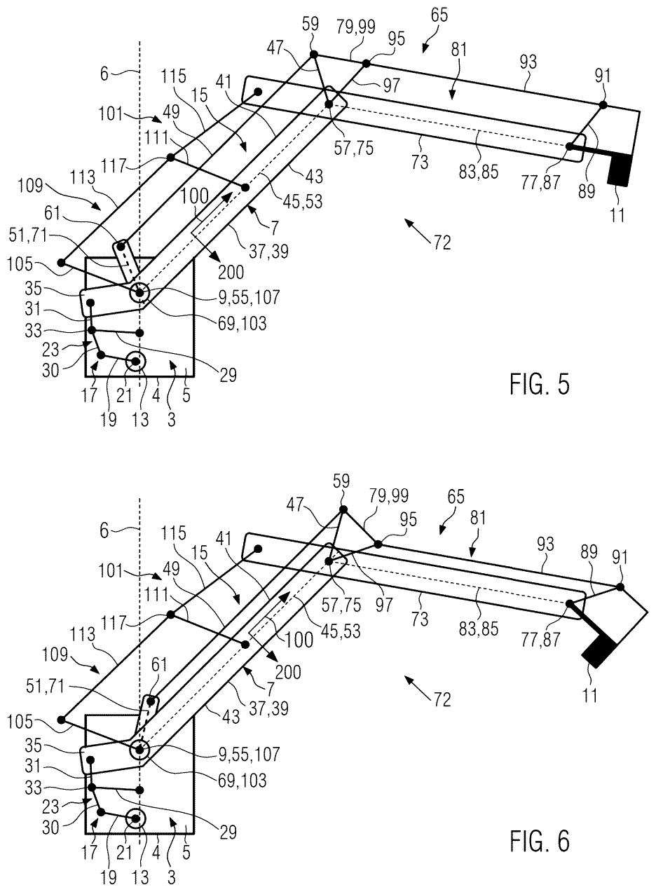

FIG. 5 shows a schematic representation of a robot according to a third embodiment, wherein the end effector is in a first orientation.

FIG. 6 shows a schematic representation of the robot shown in FIG. 5, wherein the end effector is in a second orientation.

FIG. 1 shows a robot 1 being configured as a robotic palletizer according to a first embodiment of the invention. The robot 1 comprises a base 3. The base 3 comprises a mounting part 4 and a rotatable part 5. The rotatable part 5 is rotatable about a first robot axis 6. The robot 1 comprises a pivot arm 7. The pivot arm 7 is pivotally connected to the base 3 about a second robot axis 9. The robot 1 comprises an end effector 11. The end effector 11 is adapted to be moved by pivoting the pivot arm 7. The robot 1 comprises a first drive 13. The first drive 13 is mounted onto the base 3 or is contained within the base 3. As being part of an end effector orientation determining linkage, a first parallelogram linkage 15 is kinematically arranged in between the base 3 and the end effector 11.

The first parallelogram linkage 15 is adapted for maintaining an orientation of the end effector 11 when the pivot arm 7 is pivoted. The pivot arm 7 is pivotable about the second robot axis 9 by means of the first drive 13. For this purpose, a first drive linkage 17 is provided.

The first drive linkage 17 comprises a first crank 19. The first crank 19 is pivotally connected to the base 3 about a first pivot axis 21. A first link 23 connects the first crank 19 and the pivot arm 7. The first drive 13 is adapted for pivoting the first crank 19 and the pivot arm 7.

The first drive linkage 17 comprises a first rocker 29. The first rocker 29 is pivotally connected to the base 3. The first link 23 comprises a first link element 30 and a second link element 31. The first link element 30 is pivotally connected to the first crank 19. The second link element 31 is pivotally connected to the pivot arm 7. The first link element 30 and the second link element 31 are pivotally connected via a first hinge 33. The rocker 29 is pivotally connected to the first hinge 33. The first drive linkage 17 forms at least one four-bar linkage to pivot the pivot arm 7 by means of the first drive 13.

The pivot arm 7 comprises a rocker section 35 and an arm section 37. An elongated section 39 of the arm section 37 defines a longitudinal direction 100 in a rest frame of the arm section 37. A transversal direction 200 is perpendicular to the longitudinal direction 100. First transversal side 41 and/or second transversal side 43 of the pivot arm are/is perpendicular to the transversal direction 200.

In particular, the second link element 31 is pivotally connected to the rocker section 35 of the pivot arm 7.

The first parallelogram linkage 15 is arranged on the first transversal side 41 of the pivot arm 7. Alternatively, the first parallelogram linkage 15 is arranged on the second transversal side 43 of the pivot arm 7.

The first parallelogram linkage 15 comprises a first parallelogram link 45, a second parallelogram link 47, a third parallelogram link 49 and a fourth parallelogram link 51. The first parallelogram link 45 is formed by a first section 53 of the pivot arm 7. The first parallelogram link 45 formed by the first section 53 of the pivot arm 7 extends from a first parallelogram pivot connection 55 to a second parallelogram pivot connection 57. The second parallelogram link 47 extends from the second parallelogram pivot connection 57 to a third parallelogram pivot connection 59. The third parallelogram link 49 extends from the third parallelogram pivot connection 59 to a fourth parallelogram pivot connection 61. The fourth parallelogram link 51 extends from the fourth parallelogram pivot connection 61 to the first parallelogram pivot connection 55.

In particular, the fourth parallelogram link 51 is formed by a second section 63 of the base 3.

The robot 1 comprises a connection assembly 65. The end effector 11 is connected to the connection assembly 65. The second parallelogram link 47 is formed by the connection assembly 65.

FIG. 2 shows a schematic representation of the robot 1 according to the first embodiment of the invention, wherein the end effector 11 is in a lowered position. The orientation of the end effector 11 is maintained in constant relative orientation regarding the base 3 during pivoting of the pivot arm 7.

FIG. 3 shows a schematic representation of a robot 66 according to a second embodiment, wherein the end effector 11 is in a lifted position. A change of the orientation of the end effector 11 is shown as compared to the end effector 11 of robot 1 shown in FIG. 1 and in FIG. 2.

The change of the orientation of the end effector 11 is achieved at least by means of an end effector reorientation drive 69. In the robot 66, the fourth parallelogram link 51 is formed by a second crank 71. The second crank 71 is adapted to be pivotable about the second robot axis 9 by means of the end effector reorientation drive 69 for changing the orientation of the end effector 11.

FIG. 4 shows a schematic representation of the robot 66 wherein the end effector is in a lowered position. Compared to the robot 66 shown in FIG. 3, the pivot arm 7 of robot 66 shown in FIG. 4 is pivoted while the second crank 71 is not moved by the end effector reorientation drive 69. In particular, an angular position of the second crank 71 remains constant while the pivot arm 7 is pivoted. The orientation of the end effector 11 as shown in FIG. 3, is maintained in the robot 66 shown in FIG. 4. In particular, because the first parallelogram linkage 15 is adapted to maintain the orientation of the end effector 11.

FIG. 5 shows a schematic representation of a robot 72 according to a third embodiment, wherein the end effector 11 is in a first orientation. The robot 72 comprises a support arm 73.

The support arm 73 is pivotally connected to the pivot arm 7 around a third robot axis 75. The end effector 11 is pivotally connected to the support arm 73 around a fourth robot axis 77. The connection assembly 65 further comprises a connecting member 79 and a second parallelogram linkage 81. The second parallelogram linkage 81 is connected to the first parallelogram linkage 15 by means of the connecting member 79. The first parallelogram linkage 15 and the second parallelogram linkage 81 are kinematically arranged between the base 3 and the end effector 11.

The orientation of the end effector 11 is maintained by means of the first parallelogram linkage 15, the connecting member 79 and the second parallelogram linkage 81 when pivoting the support arm 73 about the third robot axis 75.

FIG. 6 shows a schematic representation of the robot 72, wherein the end effector 11 is in a second orientation. The orientation of the end effector of the robot 72 is changed by pivoting the second crank 71 about the second robot axis 9 by means of the end effector reorientation drive 69.

The second parallelogram linkage 81 comprises a fifth parallelogram link 83 formed by a third section 85 of the support arm 73. The fifth parallelogram link 83 formed by the third section 85 extends from the second parallelogram pivot connection 57 to a fifth parallelogram pivot connection 87. The second parallelogram pivot connection 57 is about the third robot axis 75.

The second parallelogram linkage 81 comprises a sixth parallelogram link 89, which is formed by the end effector 11. The sixth parallelogram link 89 extends from the fifth parallelogram pivot connection 87 to a sixth parallelogram pivot connection 91. The fifth parallelogram pivot connection 87 is about the fourth robot axis 77. The second parallelogram linkage 81 comprises a seventh parallelogram link 93. The seventh parallelogram link 93 extends from the sixth parallelogram pivot connection 91 to a seventh parallelogram pivot connection 95. The second parallelogram linkage comprises an eighth parallelogram link 97. The eighth parallelogram link 97 is formed by the connecting member 79. The eighth parallelogram link 97 extends from the seventh parallel parallelogram pivot connection 95 to the second parallelogram pivot connection 57.

The connecting member 65 is formed as a triangle-shaped part 99 as shown in FIG. 5 and FIG. 6.

The triangle-shaped part 99 has the second parallelogram pivot connection 57, the third parallelogram pivot connection 59 and the seventh parallelogram pivot connection 95 at the vertices of the triangle 99-shaped part. The second parallelogram link 47 is formed by the connecting member 79.

In order to pivot the support arm 73 about the third robot axis 75, a second drive linkage 101 and a second drive 103 are provided. The second drive linkage 101 comprises a third crank 105. The third crank 105 is pivotally connected to the base 3 about a second pivot axis 107. The second pivot axis 107 is coaxial with the second robot axis 9. A second link 109 connects the third crank 105 and the support arm 73. The second drive 103 is adapted for pivoting the third crank 105. When the third crank 105 is pivoted by the second drive 103, a force is transmitted from the second drive 103 via the second link 109 to the support arm 73, to pivot the support arm 73 about the third robot axis 75.

The second drive linkage 101 comprises a second rocker 111. The second rocker 111 is pivotally connected to the pivot arm 7. The second link 109 comprises a third link element 113 and a fourth link element 115. The third link element 113 is pivotally connected to the third crank 105. The fourth link element 115 is pivotally connected to the support arm 73. The third link element 113 and the fourth link element 115 are pivotally connected via a second hinge 117. The second rocker 111 is pivotally connected to the second hinge 117.

The second drive linkage 101 is in the form of two four-bar linkages to pivot the support arm 73 about the third robot axis 75.

1. A robot (1, 66, 72), comprising:
a base (3) which is rotatable about a first robot axis (6);
a first drive (13);
a pivot arm (7) pivotally connected to the base (3) about a second robot axis (9);
an end effector (11) configured to be moved by pivoting the pivot arm (7);
an end effector orientation determining linkage kinematically arranged between the base (3) and the end effector (11), wherein the end effector orientation determining linkage is configured for determining an orientation of the end effector (11) when the pivot arm (7) is pivoted;
a first drive linkage (17) for pivoting the pivot arm (7), wherein the first drive linkage (17) comprises:
a first crank (19) pivotally connected to the base (3) about a first pivot axis (21);
a first link (23) connecting the first crank (19) and the pivot arm (7);
wherein the first drive (13) is configured for pivoting the first crank (19);
wherein the robot further comprises:
a support arm (73);
a second drive linkage (101); and
a second drive (103);
wherein the second drive linkage (101) comprises:
a third crank (105) pivotally connected to the base (3) about a second pivot axis (107), wherein the second pivot axis (107) is coaxial with the second robot axis (9); and
a second link (109) connecting the third crank (105) and the support arm (73);
wherein the second drive (103) is configured for pivoting the third crank (105);
wherein the support arm (73) is pivotally connected to the pivot arm (7) around a third robot axis (75);
wherein the end effector (11) is pivotally connected to the support arm (73) around a fourth robot axis (77);
wherein the end effector orientation determining linkage is configured to orient the end effector (11) about the fourth robot axis (77).

2. The robot according to claim 1, wherein the first drive linkage (17) further comprises a first rocker (29);
wherein the first rocker (29) is pivotally connected to the base (3);
wherein the first link (23) comprises a first link element (30) and a second link element (31);
wherein the first link element (30) is pivotally connected to the first crank (19);
wherein the second link element (31) is pivotally connected to the pivot arm (7);
wherein the first link element (30) and the second link element (31) are pivotally connected via a first hinge (33); and
wherein the first rocker (29) is pivotally connected to the first hinge (33).

3. The robot according to claim 2, wherein the pivot arm (7) comprises a rocker section (35) and an arm section (37), wherein the rocker section (35) and the arm section (37) extend in different directions with respect to the second robot axis (9), wherein the second link element (31) is pivotally connected to the rocker section (35).

4. The robot according to claim 1, wherein the end effector orientation determining linkage comprises a first end effector orientation determining four-bar linkage (15).

5. The robot according to claim 4, wherein the first end effector orientation determining four-bar linkage (15) and the first drive linkage (17) are configured to be at least partially and at least temporarily arranged on one transversal side (41, 43) of the pivot arm (7).

6. The robot according to claim 4, wherein the first end effector orientation determining four-bar linkage (15) and the first drive linkage (17) are arranged on opposite transversal sides (41, 43) of the pivot arm (7).

7. The robot according to claim 4, wherein:
the first end effector orientation determining four-bar linkage (15) comprises:
a first orientation determining link (45) formed by a first section (53) of the pivot arm (7) and extending from a first orientation determining link pivot connection (55) to a second orientation determining link pivot connection (57);
a second orientation determining link (47) extending from the second orientation determining link pivot connection (57) to a third orientation determining link pivot connection (59);
a third orientation determining link (49) extending from the third orientation determining link pivot connection (59) to a fourth orientation determining link pivot connection (61); and
a fourth orientation determining link (51) extending from the fourth orientation determining link pivot connection (61) to the first orientation determining link pivot connection (55).

8. The robot according to claim 7, wherein the fourth orientation determining link is formed by a second section (63) of the base (3).

9. The robot according to claim 7, further comprising an end effector reorientation drive;
wherein the fourth orientation determining link (51) is formed by a second crank (71); and
wherein the second crank (71) is configured to pivot around the second robot axis (9) by means of the end effector reorientation drive (69) for changing the orientation of the end effector.

10. The robot according to claim 7, further comprising a connection assembly;
wherein the end effector (11) is connected to the connection assembly (65); and
wherein the second orientation determining link (47) is formed by the connection assembly (65).

11. The robot according to claim 10, wherein the connection assembly (65) further comprises:
a connecting member (79); and
a second end effector orientation determining four-bar linkage (81);
wherein the second end effector orientation determining four-bar linkage (81) comprises:
a fifth orientation determining link (83) formed by a third section (85) of the support arm (73) and extending from the second orientation determining link pivot connection (57) to a fifth orientation determining pivot connection (87), wherein the second orientation determining pivot connection (57) is about the third robot axis (75);
a sixth orientation determining link (89) formed by the end effector (11) and extending from the fifth orientation determining link pivot connection (87) to a sixth orientation determining link pivot connection (91), wherein the fifth orientation determining link pivot connection (87) is about the fourth robot axis (77);
a seventh orientation determining link (93) extending from the sixth orientation determining link pivot connection (91) to a seventh orientation determining link pivot connection (95); and
an eighth orientation determining link (97) formed by the connecting member (79), extending from the seventh orientation determining link pivot connection (95) to the second orientation determining link pivot connection (57).

12. The robot according to claim 11, wherein the second end effector orientation determining four-bar linkage (81) is connected to the first end effector orientation determining linkage (15) by means of the connecting member (79);
wherein the first end effector orientation determining four-bar linkage (15) and the second end effector orientation determining four-bar linkage (81) are kinematically arranged between the base (3) and the end effector (11).

13. The robot according to claim 11, wherein the connecting member (79) is formed as a triangle-shaped part (99) having the second orientation determining link pivot connection (57), the third orientation determining link pivot connection (59) and the seventh orientation determining link pivot connection (95) at the vertices of the triangle-shaped part (99).

14. The robot according to claim 4, wherein the first end effector orientation determining four-bar linkage (15) is a first parallelogram linkage and the orientation determining links are parallelogram links.

15. The robot according to claim 11, wherein the second end effector orientation determining four-bar linkage (81) is a second parallelogram linkage and the orientation determining links are parallelogram links.

16. A method of operating a robot (1, 66, 72) as a robotic palletizer, wherein the robotic palletizer comprises:
a base (3) which is rotatable around a first robot axis (6);
a pivot arm (7) pivotally connected to the base (3) around a second robot axis (9);
an end effector (11) configured to be moved by pivoting the pivot arm (7);
an end effector orientation determining linkage comprising a first parallelogram linkage (15) kinematically arranged between the base (3) and the end effector (11);
a first crank (19) pivotally connected to the base (3) about a first pivot axis (21);
a first link (23) connecting the first crank (19) and the pivot arm (7); and
a first drive (13) for pivoting the first crank (19);
wherein the robotic palletizer further comprises a support arm (73);
a second drive linkage (101);
a second drive (103);
wherein the second drive linkage (101) comprises:
a third crank (105) pivotally connected to the base (3) about a second pivot axis (107), wherein the second pivot axis (107) is coaxial with the second robot axis (9); and
a second link (109) connecting the third crank (105) and the support arm (73);
wherein the second drive (103) is configured for pivoting the third crank (105);
wherein the support arm (73) is pivotally connected to the pivot arm (7) around a third robot axis (75); and
wherein the end effector (11) is pivotally connected to the support arm (73) around a fourth robot axis (77);
wherein the end effector orientation determining linkage is configured to orient the end effector (11) about the fourth robot axis;
wherein the method comprises:
moving the end effector (11) by pivoting at least the pivot arm (7) by pivoting the first crank (19) while keeping an orientation of the end effector (11) substantially constant by the first parallelogram linkage (15).
